(19) United States
(12) Patent Application Publication
(10) Pub. No.: US 2002/0147735 A1
(43) Pub. Date: Oct. 10, 2002

(54) Method and system for optimizing file loading in a data communication network

(75) Inventor: Ilana Nir, Halfa (IL)

Correspondence Address: DARBY & DARBY P.C., POST OFFICE BOX 5257, NEW YORK, NY, 10150-5257, US

(73) Assignee: INTRA INC.

(21) Appl. No.: 09/829,051

(22) Filed: Apr. 9, 2001

Related U.S. Application Data
(60) Provisional application No. 60/252,729, filed on Nov. 22, 2000.

(51) Int. Cl. G06F 12/00

(52) U.S. Cl. 707/200

(57) ABSTRACT

A method and system for pre-processing a set of related files associated with an application driver and stored on a computer server system is disclosed. The set of files is analyzed in order to determine the application-specific loading sequence within the set of files. The loading sequence hierarchy is encoded into a file usage hierarchy data structure in order to enable the sorting and the packaging of the analyzed files into transmittable structured file archives sorted according to the proper loading sequence. Based on the packaging, the application driver is modified to replace in the body thereof a set of references to the packaged files with references to the transmittable file archives. When the application driver is downloaded to a client system the associated file archives are transmitted concurrently for optimal processing on the receiving system.

### CROSS-REFERENCE

Priority Is Being claimed Under 35 USC §119(b) from U.S. Provisional Application Serial No. 60/252,729 filed Nov. 22, 2000 the entire disclosure of which is incorporated by reference

### BACKGROUND OF THE INVENTION

1. Field of the Invention

The present invention relates to a method for optimizing file loading in a computing and communication environment, in general and to a method and system, which optimizes the loading of class files and other resource files constituting a Java software application within a data communication network, in particular.

2. Discussion of the Related Art

The rapid development of data communication networks provides users of a computing system with the option of connecting to remote information sources associated with diverse other computing systems. Thus network users has access to an extensive amounts of useful information previously unavailable in an electronic medium. Electronic information transferred between computing systems is typically presented in hypertext, a metaphor of representing information such that text, images, sounds, and actions are linked together in a complex non-sequential net of associations by the author of a hypertext document that provides the user with the capability to traverse the dynamically growing net in order to follow a path along which the desired information is located. Typically the link contents are address values pointing to an another location within the original document or to other files conceptually linked to the document. Thus the links content are dependent on the intent of the document. Files pointed at by the embedded links could be other hypertext documents with textual content or could be files having rich media content such as sound, graphics, pictures, and video.

A typical networking environment that utilizes hypertext files and associated media files is structured as a client/server environment in which a client is usually a computer system that requests a service provided by another computer. The client system utilizes the requested service by accessing shared information sources within a network provided by an another computer system. The computer system providing the service is referred to as the server system. Client and server communicate with one another utilizing the functionality provided by a suitable network protocol such as the HTTP (Hypertext Transfer Protocol). Active within the client system is a process known as the network browser. The browser is responsible for the establishment of the connection with the server system and for displaying the retrieved information to the user of the client system. The server system executes corresponding server software, which responds to the requests for service by presenting appropriate information to the client system. Typically the responses correspond to pre-formed Hypertext documents or Web pages.

In addition to text, graphics, pictures, sound, and video the information transmitted between the client and the server could include executable code. The executable code is typically referred to as an applet (small application). An applet is essentially a small piece of code, such as a subroutine, that can be transported over the data communication network. An applet that comes as part of a requested Web page optionally includes several associated files, each of which has to be downloaded to the client system along with the Web page. Applets could be embedded in line as objects in Web pages, and executed on the target computer platform. Applets are typically developed using the Java programming environment.

Java is an object-oriented programming language expressly designed by Sun Microsystems, Inc for use in the distributed environment of a data communication network such as the Internet. Java is modeled after C++ but was designed to be smaller, simpler, and portable across platforms and operating systems. As Java enforces the object-oriented programming model a small application module in Java or an applet is implemented by creating a subclass of Java's Applet class. The applet typically utilizes other class files included within Java class libraries, user-defined classes, and associated auxiliary resources such as text, sound, video, and graphics files.

The driver of the applet is an HTML document or a Web page. The driver Web page is usually separate from the applet file and contains an APPLET tag, which refers to the applet. The APPLET tag basically points to a suitable applet file. When the Web page is downloaded to the network browser of the client system the page is appropriately processed by the browser according to the various tags appearing in the body of the Web page. When the browser identifies the APPLET tag within the Web page the downloading of the applet is effected. Subsequently the applet initializes itself and commences running thereby providing the user with the capability of viewing and interacting with the applet. Typically initialization involves the loading of other classes and additional resources such as image files, and sound files by the applet. The additional classes are usually contained within class libraries that provide basic data types, system input and output capabilities, and other utility functions. As a rule the class libraries are built-in components of the network browser. If the classes referred to by the import command of the origin class are not part of the browser then the browser attempts to find them on the server system by the creation of a new connection between the client platform and the server platform via the communication network. Usually most high-level class files include references to further classes that have to be downloaded, initialized and executed by the network browser. Class files could include references to additional resource files such as images, video, sound, virtual reality, and the like. Furthermore when the user closes a Web page the applet's execution is stopped and when the page is opened again the applet is re-loaded. In this case all the applet-dependent class files and auxiliary resource files are re-loaded as well. Thus, the full process of executing an applet within a Web page involves several distinct network connections and therefore can be substantially time-consuming.

A JAR (Java ARchive) file is a data structure that contains the class, image, video, text, and sound files for a Java applet gathered into a single file and compressed for faster transmittal to a network browser within a client system. By putting the entire set of class files and additional resource files into in a single compressed file, substantial saving in download time is accomplished. Java program development environments include suitable utilities for the manipulation of JAR files. The utilities effect the creation, the listing, and the extraction of the individual files from a JAR file. Typically, a network browser user will not need to open or view a JAR file directly as it is opened when the Web page is received and the applet is initiated in a manner known in the art.

The JAR file format is based on the popular ZIP format. JAR can be used as a general archiving tool, but the primary motivation for its development was that Java applets and the requisite components thereof such as class files, image files, and sound files can be downloaded to a network browser in a single HTTP transaction rather than opening a new connection for each different component. Thus, a considerable improvement is achieved regarding the speed with which the applet is loaded onto a Web page and commences functioning.

The organization of the applet-related class files and associated auxiliary resource files within a JAR archive is essentially random where no consideration is taken to the loading sequence of the files during the execution life-cycle of the applet. It will be easily perceived by those with ordinary skill in the art that it will be advantageous to functionally assess the applet-specific loading sequence of the various class files associated with the applet, to create a more efficient organization of JAR archives coupled to the HTML page and to provide a mechanism for operatively effective sequencing of the class and resource files within functionally ordered set of archives.

### SUMMARY OF AN EMBODIMENT OF THE PRESENT INVENTION

One aspect according to an embodiment of the present invention regards a computing environment accommodating a plurality of client systems in communication with one or more server systems. The computing environment includes a method for pre-processing a set of files in a first computer system into sorted file archives to be transferred and to be optimally re-loaded within a second computer system. The method consists of identifying a set of files within the first computer system, analyzing the usage sequence hierarchy within the set of files in the first computer system, establishing a file usage hierarchy structure in the first computer system, and structuring the set of files having a file usage hierarchy relationship established into file archives sorted and organized according to the established file usage hierarchy. The set of files include at least two files.

A second aspect according to an embodiment of the present invention regards a computing environment having a server system connected to a data network via a communication device, and a storage device holding files and a file loading optimizer application. The file loader optimizer application consists of the elements of a file analyzer to determine the sequential loading order among at least two distinct files in a set of files, a file processor for selecting and loading a distinct file, a file packager to structure at least two distinct files into file archives which are sorted and organized according to predefined structuring rules.

A third aspect according to an embodiment of the present invention regards a computing environment accommodating at least one client system connectable to one or more server systems. The computing environment includes a method of optimally organizing a set of files in a first computer system into structured file containers to be transferred to and processed within a second computer system. The method includes the steps of scanning a set of files in the first computer system, analyzing the file loading sequence relationships within the set of files in the first computer system, building a file loading sequence hierarchy structure in the first computer system, packaging the set of files having an established file loading sequence hierarchy into structured file containers organized according to the file loading sequence hierarchy relationships and a predefined set of rules.

The above aspects of the present invention provide for the optimized execution of the application downloaded to the second computer system.

The above aspects of the present invention provide for a substantially optimizing the loading of the entire set of files associated with an application downloaded to the second computer.

The above aspects of the present invention provide for substantially improving the performance of the second computer system.

The above aspects of the present invention provide for substantially easing the load on the communication devices of the communication environment.

### BRIEF DESCRIPTION OF THE DRAWINGS

The present invention will be understood and appreciated more fully from the following detailed description taken in conjunction with the drawings wherein:

FIG. 1 is a schematic illustration of an exemplary computing and communication system capable of providing a suitable environment for the operation of a preferred embodiment of the present invention; and

FIG. 2 is a high level flow diagram of the method of operation of the file loading optimizer application, in accordance with a preferred embodiment of the present invention; and

FIG. 3 is a high level flow diagram illustrative of the operation of processing the origin applet file, in accordance with a preferred embodiment of the present invention; and

FIGS. 4 is a schematic illustration of the structure of the file usage tree, in accordance with a preferred embodiment of the present invention; and;

FIG. 5 is a schematic illustration of the packaged class files, in accordance with a preferred embodiment of the present invention.

### DETAILED DESCRIPTION OF EMBODIMENTS OF THE PRESENT INVENTION

A method for the optimization of the loading of executable files and resource files of a software application operative within a data communication network is disclosed. The optimization is accomplished by organizing the files within compressed downloadable packages according to the predetermined loading sequence. In the preferred embodiment of the present invention the data communication network is the Internet and more specifically the World Wide Web (Web), the downloadable files are class files and resource files such as image, video, text, and sound files of a software application developed in the Java programming language. It will be apparent to one with ordinary skill in the art that the following description is provided merely in order to facilitate a thorough understanding of the present invention and should not be construed as limiting of other possible embodiments and/or alternative uses that are contemplated without departing from the spirit of the invention or the scope of the appended claims. In other embodiments the data network could be a Local Area Network, a cellular telephone network, a satellite network, or any other communication network involving delivery of diverse content in appropriate formats among operatively communicating remote nodes spread over geographically or topographically separate locations. In addition, in other embodiments of the present invention the software application could be developed by utilizing other programming tools such as JScript, ActiveX, JavaScript, VBScript, and the like.

The proposed method and system achieves the objectives thereof in the following manner. Client systems operating on computer platforms interface to server systems operating on other computer platforms in order to request interaction with information units contained therein. The request is fulfilled by the transmission of suitable files including the requested information from the server platform to the client computer platform. The transmission of the files is referred to as downloading. Downloaded files are usually Web pages. Web pages typically consist of text and specific markup codes inserted therewith, which instruct a client system application, such as a Web browser how to display the text, embedded within the Web page. Markup symbols are also used as references or links to other files such as small Java applications or “applets”. In order to reference an applet a distinct markup symbol <APPLET> is employed within the body of the hosting Web pages. The <APPLET> symbol in its simplest form includes parameters such as CODE, WIDTH, and HEIGHT. The value of CODE is the name of the applet to be loaded while WIDTH and HEIGHT define the width and the length of the specific area in which the applet is displayed. There are a number of additional parameters associated with the utilization of the <APPLET> markup symbol. Parameters relevant to the method and system disclosed by the present application are the ARCHIVE symbol and the PARAM symbol. The ARCHIVE symbol is used in order to package a number of applets into a single archive file. The value of the ARCHIVE is typically one or more file identifiers associated with the respective files to be bundled into a single archive file. The applet configuration can be customized with a parameter predefined by the developer of the applet. Such custom parameter is distinguished by the symbol <PARAM>. For example the string “<PARAM NAME=backgroundcolor VALUE=blue>” will color the background of the displayed image of the specific applet. Applets are executable binary files that perform various functions on the client system within the context of the Web page. Applets are downloaded to the client system alongside the hosting Web page. Applets typically include references to other executable files such as Java class files, which in turn can reference more class files. Applets and associated class files can reference other resources as well such as image files, sound files, video files, text files, and the like. Each and every referenced or sub-referenced file must be loaded from a storage device and downloaded to the client platform. As a result the number of network connections during the processing of a single Web page can be unduly high. In order to save on the number of connections the downloadable files such as the class and resource files are packaged into specific archive files such as Java Archive (JAR) files and downloaded to the client systems alongside the Web page. As the existing tools for the packaging of the files are not advanced enough to provide transmission of files in the proper loading sequence the present invention proposes a method and system for analyzing the entire set of files associated with a given Web page, determining the suitable loading sequence and building a set of packages which hold the downloadable files in a substantially correct loading sequence. The set of files include at least two files. The file loading optimizer application loads the set of Web pages stored on a server platform and scans the pages successively for the presence of the APPLET tag which signifies the potential loading of a Java applet. Furthermore the PARAM tag attached to the APPLET tag can reference additional resource files such as image, video, text, and sound files. When the APPLET tag is found the specific applet referred to is loaded and processed by the application. From the PARAM tag the resource file values are extracted, the files are loaded and processed by the application. The application detects and extracts the entire set of the references to private class files and additional resource files in the original applet code. The detection process scans recursively the entire set of private class files and resource files that the application detects until no more references to private files or resource files are found. An organized loading sequence file is created according to the detection process and the downloadable files detected are packaged according to predefined loading sequence-related rules into a set of archive files designed to be transmitted to the client platform in an optimized manner. The Web page is “wrapped” i.e., the APPLET tags are modified by the accommodation of the ARCHIVE parameter with a list of the packages created. The original Web pages are replaced by the wrapped pages and stored on the server system with the suitably created set of packages containing the files sequenced in the proper loading series. Subsequent to requests from a client system regarding specific Web pages the requested pages will be downloaded with the associated and properly organized archives.

As a result, the files will be transferred faster over the data network and thus the downloading times of the requested pages and associated files will be substantially reduced. The private files and associated resource files referenced by the APPLET tags and PARAM tags in the downloaded page will be transmitted efficiently according to the right loading sequence and therefore will be on the client system when referenced by the client software such as a network browser. The number of file requests made by the client system to the server system will be substantially reduced as well. Traffic load on the server will be diminished and the performance of the server system will improve considerably.

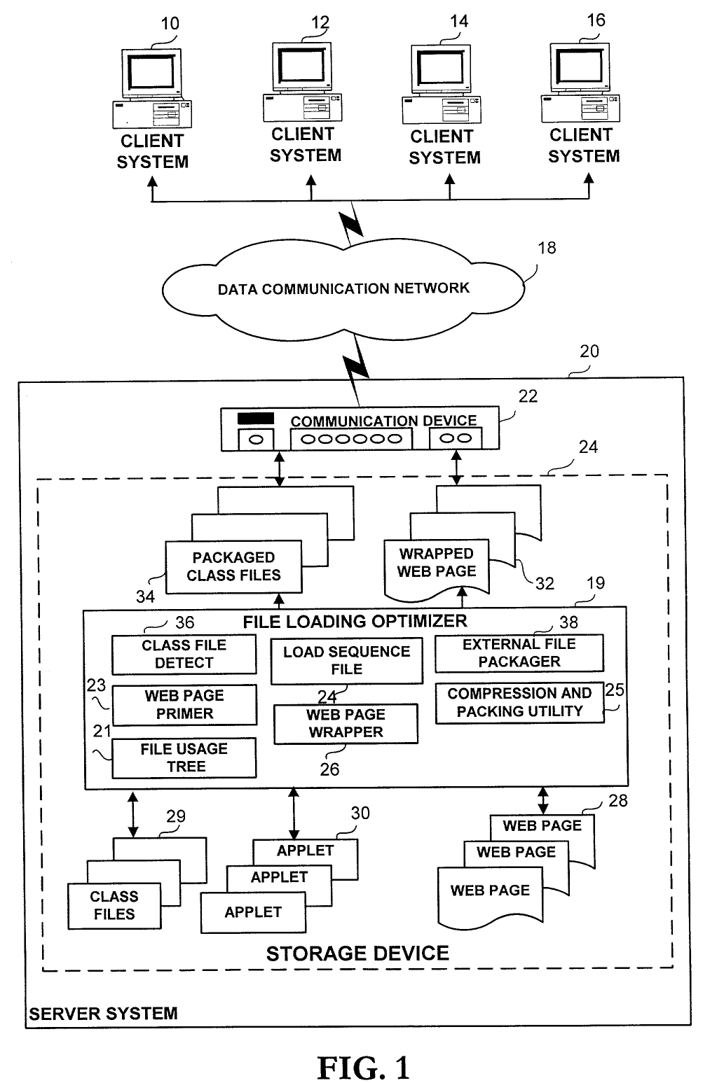

Reference is now made to FIG. 1 that illustrates an exemplary computing and communication environment in which the preferred embodiment of the present invention is operative. Client systems 10, 12, 14, and 16 operate on computer platforms within a data communication network such as the Internet. Client system 10, 12, 14, and 16 are communicatively linked to server system 20 via the data network 18. The link is accomplished by utilizing suitable communication devices such as a modem or a network interface card and standard communication lines. Server system 20 is implemented on a computer platform within a data communication network. Server 20 contains communication device 22, and storage device 24. Communication device 22 is operative in connecting server 20 to data network 18. Device 22 can be any of the standard communication devices such as a modem or a network interface card. Storage device 24 holds the various software components and associated data structures operative in the implementation of the file loading optimizer application. Device 24 comprises file loading optimizer 19, Web pages 28, applet file 30, class, image, text, and sound files 29, wrapped Web pages, 32, and packaged class, image, and sound files 34. File loading optimizer application 19 is operative to analyze the loading sequence of the class, image, text, and sound files 29 regarding the execution of applet 30 and the display of Web page 28. Application 19 also creates archives of packaged class and resource files 34 according to a specifically detected file loading sequence, originally predetermined by the execution logic of applet 30. Application 19 also replaces original Web pages 218 with wrapped Web pages 32. Pages 32 are having the APPLET tags thereof expanded with the suitable ARCHIVE parameter to effect proper downloading of the associated archives. File loading optimizer application 19 contains Web page primer routine 23, Web page wrapper routine 26, class file detector routine 36, external file packager 38, and compression and packing utility 25. Web page primer 23 is designed to load the entire set of operative Web pages 28 stored on server system 20 in order to scan the pages for the presence of APPLET tags. Class file detector 36 loads and recursively processes applets 30, associated private class and resource files 29 in order to detect references to further private class and resource files 29 within the currently processed structures. File usage tree 21 holds the loading sequence list of the processed files. External file packager 38 will insert the class and resource files into specific archives utilizing compression and packing utility 25. Web page wrapper 26 will process the original Web pages 28 to replace existing APPLET tags by similar tags with attached ARCHIVE parameter values and replace original Web pages 28 with wrapped Web pages 32.

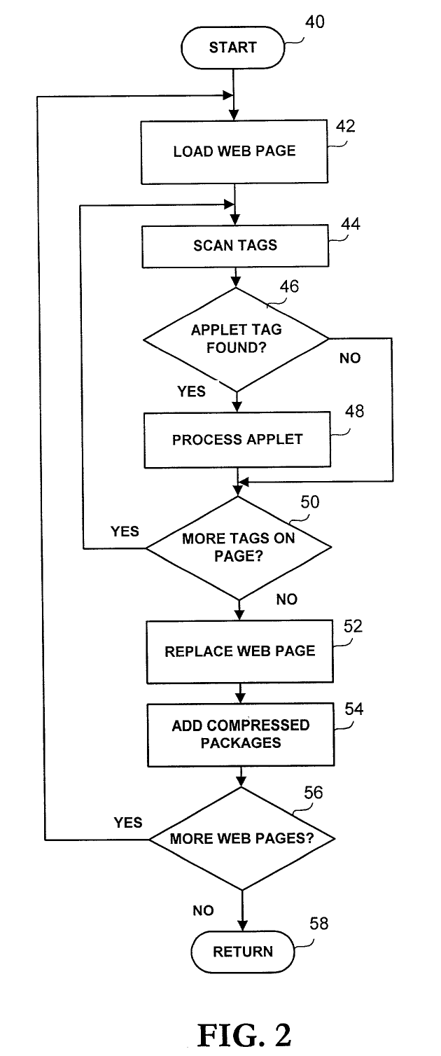

Referring now to FIG. 2 the file loading optimizer application 19 of FIG. 1 starts execution at step 40. At step 42 a web page 28 of FIG. 1 is loaded from storage. At step 44 the tags of the page are scanned for the existence of an APPLET tag. At step 46 it is determined whether the scanned tag is an APPLET tag. If the tag is an APPLET then at step 48 the referenced applet is suitably processed and program control passes to step 50. When it is determined that the current tag is not an APPLET type tag then program control passes to step 50 to test whether there are more tags to be scanned on the current page. If the result of the test is positive then program control passes to step 44 in order to perform the inner loop across steps 44 through 50 as long as there are more tags to check on the current page. The above-mentioned inner loop consists of: a test regarding the identity of current tag, a processing of the applet if the tag is of the APPLET type, and an another test regarding the presence of more tags on the current page. When at step 50 it is determined that the current page has no more tags to check program control exits the inner loop. At step 52 the web page 28 of FIG. 1 is replaced by wrapped Web page 32 of FIG. 1. At step 54 the packaged class and resource files 34 of FIG. 1 are stored. At step 56 it is determined whether there are more web pages to process. It the result is positive then program control passes to step 42 in order to execute the outer loop across steps 42 through 56 as long as there are web pages left to process. When at step 56 it is determined that the entire set of operative web pages was suitably processed program control exits the outer loop and at step 58 control returns to the server system. The file loading optimizer 19 processes the entire set of operative Web pages of a server system with associated applets, class files and resource files. The processing involves an analysis of the functional files in order to accomplish the detection of applet-specific file loading sequences. Following the analysis the downloadable files are packaged into downloadable archive files in a substantially correct loading sequence. The applet drivers such as the Web pages are operationally modified to fit the novel structure of the associated files, and the modified pages replace the entire set of functional pages stored on the server system. The applet files and associated class held on the storage devices are stored in a binary format because they have been compiled, and linked. Consequently in order to execute a required breakdown of the file structure and logic, the processed files should be disassembled by appropriate reverse engineering routines. Additionally, in order to execute the proper analysis the authorized binary format of the files should be known. The binary format of the files is freely published by the Sun Microsystems, Inc., which is the developer of the Java language. The requisite information can be obtained from the Sun Microsystems, Inc.'s Internet site identified by the URL:

http://java.sun.com/docs/books/vmspec/html/classfile.doc.html

It will be readily appreciated that any programming language having similar properties to the Java programming language can be used to program the applet files and associated class. Such may include Active X by the Microsoft Corporation of Redmond Wash., Unix Active X by the Microsoft Corporation of Redmond Wash., ADDA by the U.S. Defense Department and the like. Such may also include tools such as Shockwave by Macromedia Incorporated, and the like. Other programming language such as PROLOG and LISP having the characteristics of a byte code oriented language can be used to program the applet and class files. In such a case the user browser requires a virtual machine associated with such a language. The virtual machine compiles the applet and class file resulting in the browser running such applet and class file to achieve the required results.

At present numerous free Java utilities exist that were designed and developed in order to convert binary files compiled by the Java compiler to files having Java source code format. One example of such application's source code can be found at the web site identified by the Uniform Resource Locator:

http://www.laserstars.com/articles/ddj/insidejcf

Thus, by utilizing the free available information relating to the Java class file format and appropriately adapting one of the freely available binary code-to-source code conversion utilities, the required transformation of the compiled, binary files to source code format can be achieved and consequently the source code of the resulting files can be suitably broken down and analyzed.

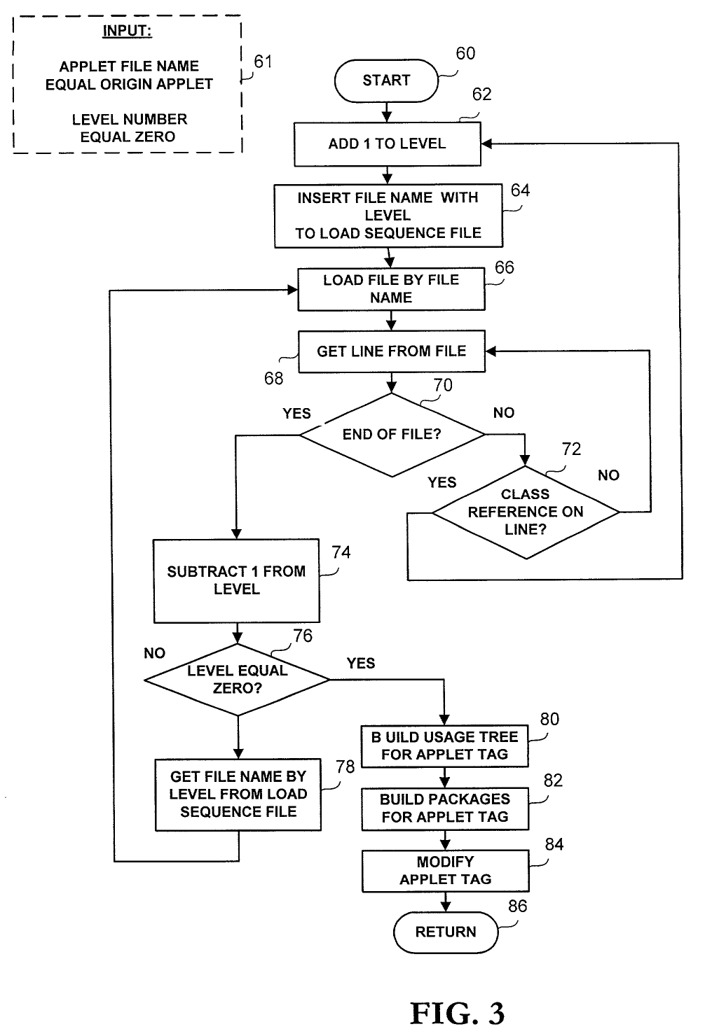

Referring now to FIG. 3 illustrative of the processing of the applet referenced in the APPLET tag of the processed Web page. The input 61 values consists of a file name set to the name of the applet to be processed, and the level number i.e., a control variable signifying the level of processing. On entry the level number is set to the value of zero. The processing begins at step 60. At step 62 the level number value is increased by the value of 1. At step 64 the file name is inserted into the load sequence file 24 of FIG. 1. Load sequence file 24 of FIG. 1 is indexed by the level number. Load sequence file 24 of FIG. 1 can have different organizations such as index-sequential organization, and the like. At step 66 the file referenced by the file name is loaded into a memory device for processing. Subsequently the file is converted from compiled, binary format to source code format (not shown) by utilizing the appropriate transformation utilities specifically adapted to the purposes of the file loading optimizing application 19. At step 68, a source code line is extracted from the file. At step 70 the file is tested for an end of file condition. If the result is negative then utilizing the known format of Java class files at step 72, the source code line is tested for the presence of a private class file or a resource file reference. If no private class reference exists on the line then program control returns to step 68 to obtain the next line from the file. In contrast, if a class reference is found on the line then program control returns to step 62 in order to recursively process the next level class reference file. Accordingly at step 62 the level number is increased by 1, at step 64 the file name of the class file is inserted into the load sequence file indexed by the level number, at step 66 the referenced class is loaded, and converted into source code format (not shown). At step 68 a source code line is extracted from the file, at step 70 a test is made regarding the end-of-file condition for the processed file and at step 72 the line is examined for the presence of a private class reference. If no class reference is detected then at step 68 the next source code line is extracted from the file to be checked. The loop that consists of steps 62 through 72 is executed for each next-level class reference detected within the set of processed class files. When at step 70 it is determined that the end of the file was reached then at step 74 the level number is decreased by the value of 1. Consequently at step 76 the level number is tested for the value of zero. When the value is higher than zero then the suitable file from the prior processed level is re-loaded for further processing. At step 78, the prior file name is extracted from the load sequence file where it was previously saved at step 64. The file is loaded at step 66, and processing continues until the end of the file is reached. For each private class reference pointing to the next-level file a loop is performed across steps 62 through 72. The performance of the loop effects the loading and the processing of a next-level file, and for each end-of file condition raised program control effects the re-loading of the prior level file by performing the loop across steps 74 through 66. Level number zero at step 76 indicates that the entire set of private class files consecutively pointed at by the current applet and the class files within the applet were suitably processed. Therefore when it is determined that the value of level number is zero then at step 80 the routine utilizes the load sequence file in order to build the file usage tree. Subsequently at step 82 the routine utilizes the file usage tree and a set of pre-defined archive packaging rules in order to create the appropriate archive package files. Next at step 84, the APPLET tag within the Web page is suitably modified. At step 86, program control returns to the main routine of the application.

The above-described processing logic is executed for each applet tag found in the processed Web page 32. For each applet the associated private class files are processed, a load sequence file is built involving the list of class and resource files indexed by the proper level number, a file usage tree is built, the detected class and resource files are suitably packaged into appropriately arranged archive files, and the APPLET tag on the Web page is modified by the addition of the ARCHIVE parameter. The ARCHIVE parameter is set to value of the associated archive file. An exemplary modified APPLET tag could have the format of:

<APPLET code = JavaDetect.class ARCHIVE = “archiveA jar, archiveB jar, archiveC.jar”

For the clarity of the explanation in the foregoing reference was made only to private class files. In addition to class file references the processing of the files involve searching for other external resource files such as image files, sound files, video files, text files, virtual reality files and the like. Thus, the analyzing of the source code can involve scanning for diverse resource files in addition to the private class files. It will be easily perceived by one of ordinary skill in the art that the handling of the additional resource files will be substantially similar to the above-described handling of the class files. The resource file names will be inserted into the load sequence file in the proper loading sequence, then copied to the file usage tree, and will be packaged into the suitable organized archive files in the substantially correct loading sequence in preparation for downloading to the client system.

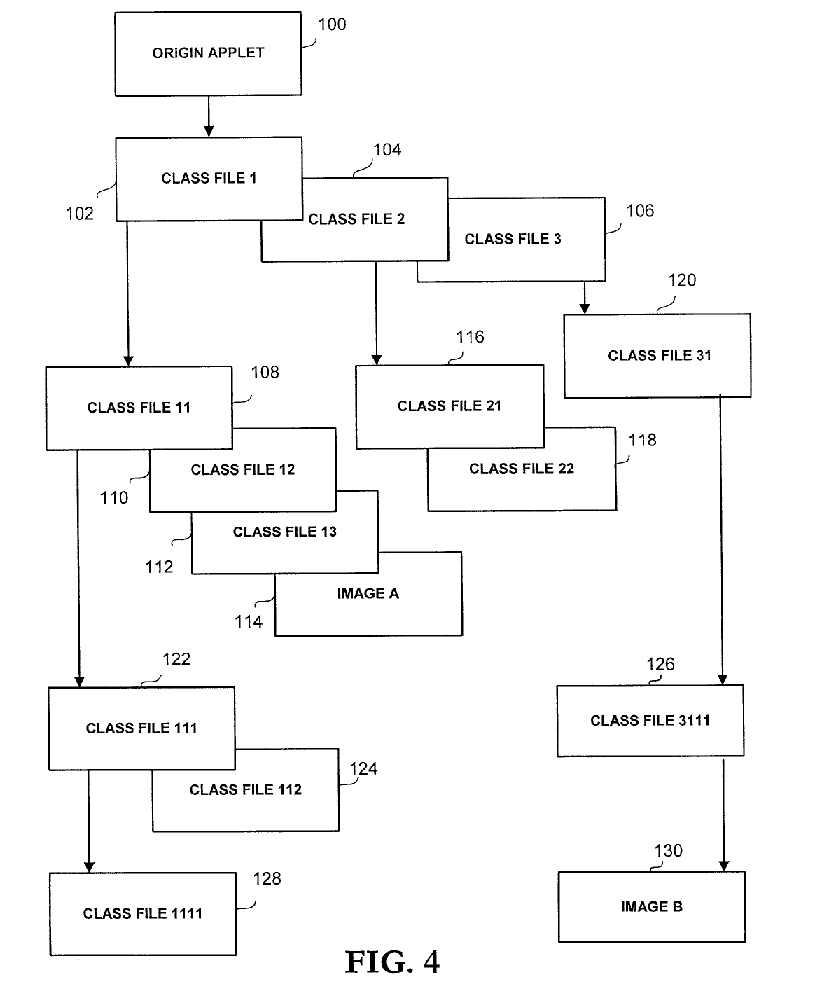

FIG. 4 describes an exemplary structure of the file usage tree 21 of FIG. 1. In the preferred embodiment of the invention, the data in the file usage tree 21 of FIG. 1 is organized hierarchically i.e., in a tree-like manner and held in a tree-like data structure. Therefore to provide a thorough understanding of the principles and operations of the present invention, the tree abstraction and associated concepts thereof will be briefly explained next.

Data structures called trees are known in the art. When information is classified by breaking a whole into parts, and repeatedly breaking the parts into subparts, it is natural to represent the classification by a tree structure. A tree has a single starting point called the “root” of the tree. In general an element of a tree is related to particular elements at the next lower level of the tree (as a parent related to children in a family tree). Some elements have no children. Because the branches do not merge, from every element of a tree one can trace a unique path back to the root. A unique downward path is called the “down-pointer”. A tree is composed of nodes and edges. The nodes are any distinguishable objects at all, for example, data records. Nodes can have descendant nodes or children. Nodes with descendant nodes are called the father nodes of descendants thereof. Nodes belonging to the same father node called brother nodes or sister nodes. A unique path between brother or sister nodes is called a “continuation pointer”. An edge is an ordered pair of nodes i.e., a connection between two component data records. A leaf is a node with no children nodes or descendant nodes.

In the preferred embodiment of the present invention, the list of class and resource file names is stored within the nodes of the file usage tree where the hierarchical relations between the class/resource files are represented by the hierarchically organized nodes of the tree structure. The name of the origin applet is held in the “root” of the tree or node 100. The class references representing class file names within the source code of the origin applet stored within nodes 102, 104, 106 pointed at by the root node 100 via the edge connecting root node 100 and node 192 containing file name 1. Node 102 points to the brother node 104 thereof storing class file name 2, which in turn points to the brother node 106 thereof storing class file name 3. The data is organized within the nodes of the tree in this manner to indicate that class files 1, 2, and 3 are stored within the nodes 102, 104, and 106 respectively and therefore are included within the source code of origin applet 100 stored in the “father node” or the root node 100. In a similar manner node 102 points to nodes 108, 110, 112, and 114. As node 102 stores class file 11 and the “children” nodes 108, 110, 112, and 114 store class file 11, class file 12, class file 13, and image resource file A respectively, the organization of the data indicates that the source code of class file 1 includes references to class file 11, to class file 12, to class file 13, and to image file A. The “father nodes” points to the “children” nodes by means of a logical pointer value called the “down pointer”. Each down-pointer indicates a next level node or nodes. Therefore node 100 is the root node or the first-level node, nodes 102, 104, and 106 are the next-level nodes by virtue of the down-pointer connecting root node 100 with node 102. On the same level the different nodes are connected by logical pointer values called continuation pointers. It will be clear to one skilled in the art that by means of the above-described data structure the specific hierarchical relationships between the related class/resource files will be precisely described.

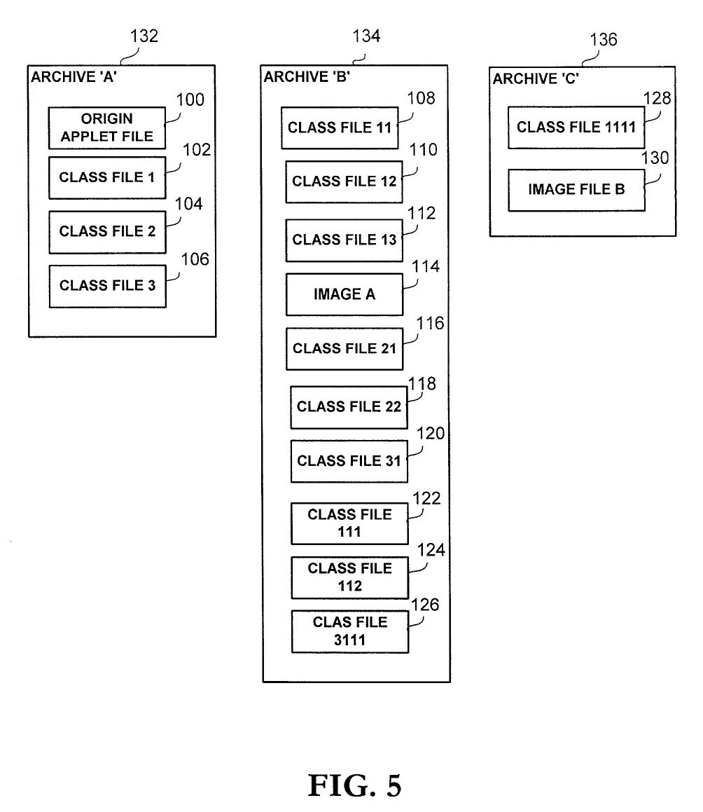

FIG. 5 is a schematic block diagram illustrative of an exemplary structure of the packaged archive files. In the preferred embodiment of the present invention the archives are of the JAR (Java Archive) type. JAR is a file format used for aggregating many files into one. JAR is used as a general archiving tool to enable Java applets and the requisite components thereof to be transmitted to a requesting client system in a single HTTP transaction rather than opening a new connection for each component. The tools for the packaging, the compression and the organization of the selected files into the Java Archives are provided by the developer of the JAR utility, Sun Microsystems, Inc. In different embodiments of the present invention, other archiving tools could be utilized, such as the CABARC (Microsoft Cabinet) developed and distributed by Microsoft Corporation or the WinZip utility developed and distributed by WinZip Computing, Inc. In order to achieve substantial optimization of the file loading process the files preferably should be packaged into the archive files in the precise order of the loading thereof by the application driver i.e., by the Web page 32. In the preferred embodiment of the present invention the proper packing order is accomplished by utilizing the file usage tree 21 of FIG. 1 and a substantially complete set of predefined packaging rules. For example such rules could involve

a) Package two levels of the file usage tree into each archive file.

b) Package any additional image, sound, video, text and other resource files per level to the archive file holding class files of the same level. (This rule effects packaging of the resource files with the calling class files)

c) Invalidate the above rules in case there is a predefined limitation to the size of the archive files.

Referring to FIG. 4 and to FIG. 5 the designations of the locations for the respective files on both drawings are the similar. Also referring to the abovedescribed rules: as origin applet is stored in root node 100 (level one) of the file usage tree of FIG. 4, and class files 1, 2, and 3 are stored in second level nodes 102, 104, 106 respectively, archive file “A” 132 contains origin applet file 100, class file 1 (102), class file 2 (104), and class file 3 (106). Therefore rule a) defining that two levels have to be packaged into a single archive file is satisfied. In a similar manner level three of the file usage tree 21 of FIG. 4 contains class files 11, 12, 13, image file A, class file 21, 22, 31 located in nodes 108, 110, 112, 114, 116, 118, and 120 respectively. Level four of the file usage tree 21 of FIG. 4 contains class files 111, 112, and image B stored into the nodes of file usage tree 122, 124, and 126 respectively. Thus archive file “B” 124 of FIG. 5 will hold, class files 11 (108), 12 (110), 13 (112), image resource file A (114), class files 21 (116), 22 (118), 31 (120), 111 (122), 112 (124), and image resource file B (126) respectively. As two levels of files and additional resource files are packaged into the single archive “B” 134 of FIG. 5 the rules a) and b), defining the packaging of two levels from the file usage tree into a single archive file and further defining the additional packaging of resource files of the same level, are satisfied. Finally level four of the file usage tree 21 of FIG. 4 consists of class file 1111 and image resource file B, which are located in four-level nodes of file usage tree 128 and 130 respectively. Therefore both files 128 and 130 are packaged into the single archive “C” 136 of FIG. 5 thereby satisfying rule a) and b). In other embodiments of the present invention other data structures could be used. File usage tree 21 of FIG. 1 could have an index sequential organization or any other suitable file organization format. The foregoing description was set forth merely in order to provide an explanation of the present invention. Different logic, different routines and diverse other data structures could be used in order to achieve substantially the same objectives.

Persons skilled in the art will appreciate that the present invention is not limited to what has been particularly shown and described hereinabove. Rather the scope of the present invention is defined only by the claims, which follow.

I claim:

1. In a computing environment accommodating at least one client system connectable to one or more server systems, a method of pre-processing a set of files in a first computer system into sorted file archives to be transferred to and reloaded within a second computer system, the method comprising the steps of:
identifying the set of files in the first computer system;
analyzing a usage sequence hierarchy within the set of files in the first computer establishing a file usage hierarchy structure in the first computer system; and
structuring the set of files having the established file usage hierarchy into a plurality of file archives sorted and organized according to the established file usage hierarchy.

2. The method of claim 1 wherein the step of identifying further comprises the steps of:
determining first reference to a distinct file within the set of files;
loading the distinct file within the set of files to enable determination of a next reference to a distinct file; and
determining the next reference to the distinct file within the set of files.

3. The method of claim 1 wherein the step of analyzing comprises the step of determining a sequential loading order relationship among at least two distinct files within the set of files.

4. The method of claim 1 wherein the step of establishing comprises the step of inserting according to a determined sequential loading order the identification of at least two distinct files within the set of files into the file usage hierarchy structure.

5. The method of claim 1 of structuring further comprises the steps of:
establishing a set of file archive structuring rule;
determining according to the file archive structuring rule an insertion order of at least two distinct files within the set of files into the sorted and organized file archives; and
inserting according to the determined insertion order the at least two distinct files into the sorted and organized file archives, whereby the set of files is concurrently transmitted to the second computer system.

6. The method of claim 1 wherein the set of files includes a first distinct file, the first computer includes a first reference to the first distinct file, and further comprising the step of replacing the first reference to the first distinct file with a reference to at least one sorted and organized file archive, thereby indicating new location to the first distinct file.

7. In a computing environment and having a server connected to a data network via a communication device and a storage device holding a set of files, the set of files including at least two distinct files, a file loading optimizer comprising the elements of:
a file analyzer for determining a sequential loading order among the at least two distinct files in the set of files;
a file processor for selecting and loading one of the at least two distinct files; and
a file packager for structuring at least two distinct files into a plurality of file archives sorted and organized according to predefined structuring rules.

8. The system of claim 7 further comprising of a file driver primer for replacing references to the at least two distinct files in the set of files with a reference to one of the plurality of sorted and structured file archives.

9. The system of claim 7 further comprising a load sequence file to hold a sorted list of the at least two distinct files sequenced by the sequence loading order.

10. The system of claim 7 further comprising a file usage structure to hold a hierarchical order of the at least two distinct files in the set of files.

11. The system of claim 7 further comprising a file compressor and a file packager for structuring the sorted and organized plurality of file archives into a compressed format.

12. The system of claim 8 wherein the file driver comprises a hypertext file.

13. The system of claim 8 wherein the file driver comprises an HTML file.

14. The system of claim 7 wherein the sorted and organized plurality of file archives are Java Archive file archives.

15. The system of claim 7 wherein at least two distinct files within the set of files are Java applets.

16. The system of claim 7 wherein at least two distinct files within the set of files are Java class files.

17. The system of claim 7 wherein at least two distinct files within the set of files are one of still image, streaming video, sound, music, text, animation and virtual reality resource files.

18. In a computing environment accommodating at least one client system connectable to one or more server systems a method of organizing a set of files in a first computer system into a plurality of at least one structured file containers to be transferred to and processed in a second computer system, the method comprising the steps of:
scanning the set of files in said first computer system;
analyzing a file loading sequence hierarchy within the set of files in the first computer system;
building a file loading sequence hierarchy structure in the first computer system; and
packaging the set of files having the established file loading sequence hierarchy into a plurality of structured file containers organized according to the file loading sequence hierarchy.

19. The method of claim 18 wherein the step of identifying further comprises the steps of:
a file loading driver determining first reference to a distinct file in the set of files;
processing the distinct file within said set of files to determine a next reference to a next distinct file in the set of files; and
determining the next reference to the next distinct file in the set of files.

20. The method of claim 18 further comprising the step of transmitting at least one of the plurality of structured file containers to the second computer system.

21. The method of claim 19 further comprising replacing the file loader driver with a modified file loader driver, the modified file loader driver including a reference to the distinct file replaced with reference to one of the plurality of structured file containers.

22. The method of claim 19 wherein the modified file loader driver is a hypertext file.

23. The method of claim 19 wherein the modified file loader driver is an HTML file.

24. The system of claim 19 wherein the plurality of structured file containers are Java Archive file archives.

25. The system of claim 19 wherein the set of files is associated with a distinct HTML file.
